(19) United States
(12) Patent Application Publication
(10) Pub. No.: US 2023/0182319 A1
(43) Pub. Date: Jun. 15, 2023

(54) Automatic Gripping Module

(71) Applicant: Asutec GmbH, Nurtingen (DE)

(72) Inventor: Andreas Unterhuber, Nurtingen (DE)

(21) Appl. No.: 18/078,804

(22) Filed: Dec. 9, 2022

(30) Foreign Application Priority Data
Dec. 10, 2021 (EP) 21213654.3

(51) Int. Cl. B25J 15/02; B25J 15/00

(52) U.S. Cl. CPC B25J 15/0266; B25J 15/0028; B25J 15/0246; B25J 15/0047

(57) ABSTRACT

A gripping module grips and moves objects and can be used on robots or automatic handling machines. The gripping module has a module carrier and at least two active elements, which can be displaced relative to one another and have gripping surfaces for gripping an object. At least one of the active elements is displaceable relative to the module carrier by a drive system. The drive system has an electric motor and an actuator element displaceable by an electromagnet. The electric motor and the actuator element are each kinematically coupled to the active element.

### RELATED APPLICATION DATA

This application claims priority to and the benefit of European application no. 21213654.3 filed on Dec. 10, 2022, the entire content of which is hereby incorporated by reference herein.

### BACKGROUND

### 1. Technical Field

The present disclosure relates to a gripping module for the purpose of gripping and moving gripping objects, and in particular, as a gripping module of a robot or an automatic handling machine.

### 2. Related Art

A gripping module according to the genus and the disclosure has at least two active elements, which can be displaced relative to one another by means of a drive system and have gripping surfaces for gripping the gripping object. At least one of the active elements is designed to be displaceable so that it can be displaced relative to the other active element in order to grip the gripping object from the outside or inside, in particular in order to be able to subsequently transport it.

Known gripping modules usually have an electric motor as part of the drive system. This is designed in such a way that it can exert sufficient gripping force on the gripping object after the active elements have been moved into a contact position so that the gripping module can subsequently transport the gripping object safely.

However, a sufficiently powerful electric motor for this purpose is comparatively large, making it difficult to use in small gripping modules. In addition, such an electric motor poses a risk if the gripping module, especially as part of a robot, operates in the immediate vicinity of people.

### SUMMARY

It is the object of the present disclosure to provide a gripping module, which at least partially over-comes the above-mentioned problems of the prior art.

According to the disclosure, a gripping module is proposed for this purpose, which has a module carrier and at least two active elements in a manner customary in the art. At least one of the active elements, but in one example both active elements, can be automatically displaced relative to the module carrier by means of the drive system.

Various designs of gripper modules are possible with regard to the displaceability of the active elements, in particular those with active elements that can be displaced linearly relative to one another and in one example are guided on a common shaft guide, as well as those with active elements that can be displaced relative to one another in a pivoting manner.

The one-piece or multi-piece active elements have gripping surfaces, whereby, depending on the type of gripping from the inside or from the outside, the gripping surfaces are provided on the inside of the active elements and point towards each other or on the outside and point away from each other. In one example, gripping surfaces are provided on both sides of the active elements in order to be able to use the active elements both for internal gripping and for external gripping.

At least one of the active elements can be displaced relative to the module carrier by means of a drive system in order to move the active elements of the gripping module acting as an external gripper towards each other or to move the active elements of the gripping module acting as an internal gripper away from each other towards the outside. Although it is sufficient in principle that only one of the active elements can be displaced relative to the module carrier for this purpose, in one example at least two active elements can be displaced relative to the module carrier by means of the drive system. In the case of a gripping module with more than two active elements, all active elements can be moved together towards or away from each other by means of the drive system.

The drive system has two different mechanisms for applying force to the active elements, namely an electric motor whose primary task is to move the active elements against each other and in particular to bring them into contact with a gripping object, and an electromagnet acting on an actuator element whose primary task is to exert a gripping force on the gripping object by activating or deactivating it when the active elements are in contact with the gripping object.

The electric motor can be designed as a brushless DC motor, for example, but other types of electric motors can also be used here. In one example, the electric motor is a rather low-power motor, since such a motor is small and thus allows integration into a small gripping module. Since the electric motor may serve solely to feed the active elements, but not to apply the gripping force, an electric motor with low maximum power is usually sufficient, resulting in a maximum force between the active elements of less than 50 Newton, in particular less than 30 Newton. Such a low force offers the advantage that there is no risk of severe injury caused by the electric motor.

The actual gripping force may be caused by the electromagnet or the spring associated with it. Although the force generated by this can be quite high, depending on the design of the electromagnet and/or the spring, the risk of serious injury is also low here, since the displacement of the active elements towards or away from each other caused by activation/deactivation of the electromagnet is likely low, and in particular may be less than 2 mm, or less than 1 mm in one example.

The electromagnet can be used directly to apply force to the active elements by exerting a force on the actuator element when it is activated, which is transmitted in such a way that it applies force to the active elements in the gripping direction. However, in one example it is the force of a spring device that exerts this force application when the electromagnet is deactivated. If a power failure occurs when the gripped object is gripped, this is not relevant for maintaining the gripping force.

In particular, it is suggested that a spring device is associated with the electromagnet in such a way that the spring device can be tensioned by activating the electromagnet. If the electromagnet is deactivated, i.e. the current supply is terminated or reduced, this reduces the tension in the spring device. If the spring device is designed as a compression spring, this relaxation is accompanied by an extension of the spring device. In particular, when the spring device is in contact with the actuator element, this can push the actuator element away from the electromagnet and thereby cause the force to be applied to the actuator elements in the gripping direction. The spring device is formed by one or more helical springs in one example.

In one example, a design of the drive system provides that the drive system has a drive spindle, which is rotatably and axially movable relative to the module carrier. A translationally displaceable spindle nut is guided on the drive spindle. The spindle nut may be guided by the module carrier or other stationary components in such a way that it can only be moved translationally but cannot be rotated relative to the module carrier.

The spindle nut is kinematically coupled to the at least one active element and, in one example to at least two active elements, so that the movement of the spindle nut taking place in the direction of extension of the spindle nut exerts a force on the active elements.

The spindle nut can be displaced relative to the module carrier or support in two ways, namely firstly by rotating the drive spindle and the resulting displacement of the spindle nut, and secondly by the joint axial displacement of the drive spindle and the spindle nut. In both cases, a displacement of the spindle nut occurs.

In one example, the electric motor is coupled to the drive spindle via its output shaft in order to rotate it. For this purpose, the electric motor can be designed as a geared motor whose gear box provides a reduction or transmission ratio between a rotor shaft of the electric motor and its output shaft. However, it may be advantageous if the drive spindle is directly subjected to torque by the rotor shaft of the electric motor, i.e. without an intermediate gear box. In this way, a particularly compact design can be achieved.

The axial movement of the drive spindle may be effected via the electromagnet, in particular by the electromagnet pulling the drive spindle together with the actuator element in one direction when current is applied, and the actuator element being pressed in the opposite direction by the spring device described above when the current is removed.

In one example, the electric motor and the actuator element may be provided opposite each other on both sides of the drive spindle.

In order for the drive spindle to be movable in the axial direction relative to the module carrier, it can be fixed axially to the electric motor and the electric motor can in turn also be movable axially relative to the module carrier. In such a design, the electromagnet can be fixedly attached to the actuator element of the electromagnet and displaced by means of the electromagnet and, if necessary, a spring device.

However, a design in which the electromagnet is fixed to the module carrier may be advantageous.

To ensure that the drive spindle can nevertheless be moved axially, in this case the output shaft of the electric motor and the drive spindle are connected to each other so that they are fixed against rotation but can also be moved axially.

This can be achieved in particular by the drive spindle having a non-circular central recess to accommodate the output shaft, which is also non-circular. The depth of this recess is sufficiently large to ensure the desired degree of relative axial movement between the output shaft and drive spindle.

The axial displaceability of the electric motor relative to the drive spindle also offers the advantage of decoupling. The application of a gripping force on the gripping object can be accompanied by an abrupt load on the drive spindle. However, the axial decoupling mentioned above means that this abrupt load is not transmitted to the electric motor. This is particularly advantageous for gearless electric motors, which could otherwise be damaged by the sudden load.

A particularly compact design of the gripping module can be achieved if the electric motor is arranged between the active elements and, in particular, an output shaft of the electric motor points away from the gripping surfaces of the active elements. The orientation of the output shaft may form a right angle with the direction of movement of the active elements.

In principle, it is conceivable to connect the actuator element to the drive spindle in a rotationally fixed manner, so that the electromagnet and possibly the spring device associated with it act on this rotatable actuator element.

However, in one example the drive spindle may be rotatably mounted on the actuator element. The actuator element as a whole is then only axially displaceable, but not rotatable. A roller bearing can be provided between the actuator element and the drive spindle to achieve the rotatable mounting. Particularly in the case of small sizes of the gripping module, however, it may be advantageous to provide a plain bearing, since this can be made smaller.

In one example, the drive spindle may be connected to a pressure plate in a rotationally fixed manner. The actuator element has a receiving space for receiving this pressure plate and can thus exert a force on the pressure plate. The receiving space may surround the pressure plate from above and below in order to be able to transmit both a compressive force and a tensile force.

In principle, a design is possible in which the spindle nut itself is firmly connected to the active element at least in the axial direction of the spindle. In such a design, the active element is moved to the same extent and in the same direction as the spindle nut.

However, in one example the extent and/or direction of movement of the spindle nut may differ from that of the at least one active element. In particular, if more than one active element is to be moved by means of the spindle nut, a deviating direction of movement may be desirable and, in particular, an orientation of the drive spindle and a direction of movement of the spindle nut may form an angle of between 70° and 110° with the direction of movement of the active elements.

The force transfer between the spindle nut and the active element can be achieved, for example, by means of a spline gear.

However, it is considered particularly advantageous if the spindle nut is connected to the at least one active element via an intermediate lever. This intermediate lever can be pivoted about an axis fixed to the active element on the one hand and about an axis fixed to the spindle nut on the other. A displacement of the spindle nut is transmitted to the active element via the intermediate lever.

In such a design, the position of the said axes and the resulting position of the at least one intermediate lever influence whether a displacement of the spindle nut in a predetermined direction causes a displacement of the active elements away from or towards each other, i.e. whether the active elements are moved towards each other in the sense of an outer gripper in the gripping direction or away from each other in the sense of an inner gripper in the gripping direction.

In order to be able to use the same gripping module both as an internal gripper and as an external gripper, it can be provided that at least two swivel joint bores or swivel joint axes are provided on the spindle nut and/or on the active element, so that several options exist with regard to the attachment of the intermediate lever, namely in particular a first option that enables use as an internal gripper and a second option that enables use as an external gripper.

Such a design with at least two options for attaching the intermediate lever to the spindle nut or active element is particularly advantageous for small gripping modules. In the case of larger gripping modules, it is possible to allow a sufficiently large travel path of the spindle nut on the drive spindle, so that even with only one option for attaching the intermediate lever to the spindle nut and to the active element in each case, switching between internal gripper and external gripper is made possible by passing over a position with maximally spaced active elements. In the case of small gripping modules, the required installation space may be lacking for this, so that the design with two swivel joint bores or swivel joint axes is advantageous here.

A gripping module according to the disclosure requires a control circuit for operation, which in particular controls the electromagnet and the electric motor. This control circuit can be part of the gripping module itself and in particular be arranged in a module housing forming the module carrier, in which the electric motor and the electromagnet are also arranged. However, the control circuit can also be provided externally and connected to the electric motor or the electromagnet by means of control lines.

In one example, at least one sensor for detecting the position or an end position of at least one active element is associated with the control circuit in order to be able to detect the current position and to be able to control the active elements on the basis thereof.

A gripping module according to the disclosure can be used in different applications and with different motion systems. In particular, the use as a robot gripper or the use as a gripping module of an automatic handling system may be desirable. For coupling to the motion system, the gripping module may have a mechanical coupling device by means of which the module carrier can be coupled to a robot arm of the robot or a carriage of the automatic handling machine.

Furthermore, the present disclosure also comprises such a robot with a robot arm to which a gripping module is attached, as well as such an automatic handling machine with a translationally movable carriage to which a gripping module is attached, wherein the gripping module is designed in each case in the manner described above.

In addition to the gripping module and, based thereon, the robot and the automatic handling machine, the disclosure also relates to a method for gripping a gripping object with the following method steps.

First, two active elements of a gripping module are positioned in an initial position in which they are spaced apart from the gripping surfaces of the gripping object. In the case of an internal gripper, the said distance can be from the inward-facing gripping surfaces of the gripping object, and in the case of an external gripper, it can be from the outward-facing gripping surfaces.

Starting from this initial position, the active elements are displaced against each other by means of an electric motor until the active elements are in contact with surfaces of the gripping object. The force acting on the active elements may be less than 50 Newton in one example.

As soon as the active elements are in contact with opposite sides of the gripping object, the active elements are force-actuated against each other by activating or deactivating an electromagnet in order to exert a gripping force on the gripping object from inside or outside. The electromagnet may be deactivated for this purpose, i.e. the current supply is interrupted, so that the gripping force is achieved by a spring device that lengthens as a result of the deactivation. Such a design means that the gripping force is not lost in the event of a power failure.

In one example, the method is carried out with a gripping module of the type described above.

### BRIEF DESCRIPTION OF THE DRAWINGS

Further advantages and aspects of the disclosure are apparent from the claims and from the following description of embodiments of the disclosure, which are explained below with reference to the figures.

FIG. 1 shows a sectional view of a gripping module according to the present disclosure.

FIG. 2 shows a drive spindle of the gripping module and its kinematic coupling with the active elements of the gripping module.

FIG. 3 shows a spindle component and its rotational coupling with an output shaft of an electric motor of the gripping module.

FIGS. 4A to 4C show the operation of the gripping module when it is used as an external gripper.

FIGS. 5A to 5C show the operation of the gripping module when it is used as an internal gripper.

FIG. 6 shows an industrial robot according to the present disclosure with a gripping module according to the disclosure.

FIG. 7 shows a handling machine according to the present disclosure with a gripping module according to the disclosure.

### DETAILED DESCRIPTION OF THE EMBODIMENTS

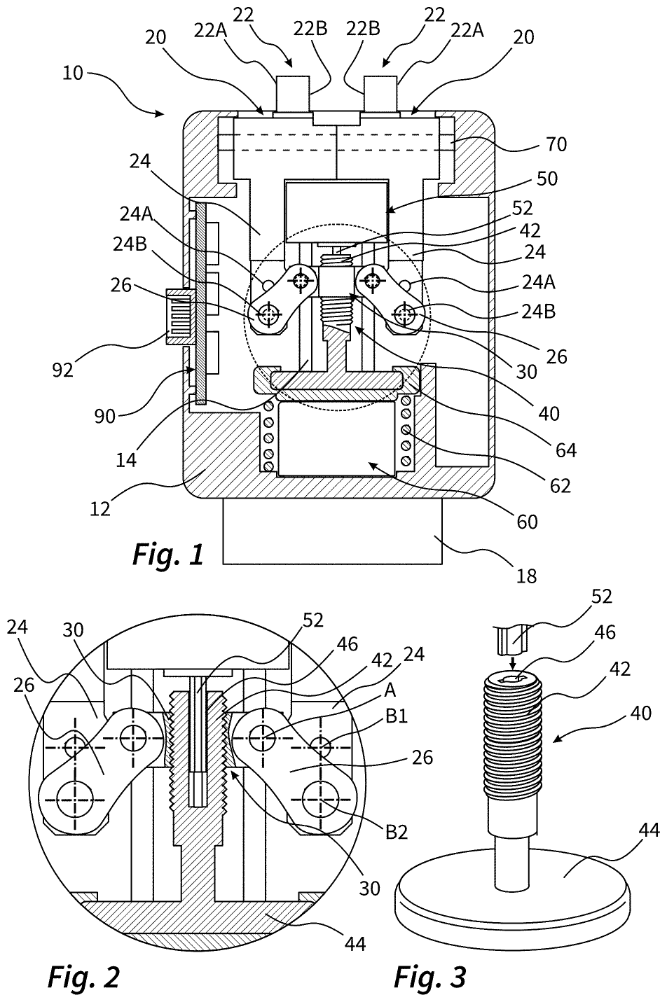

FIG. 1 shows a sectional view of a gripping module 10 according to the present disclosure. FIG. 2 shows a partial section of FIG. 1 enlarged and partially cut in a different way.

The gripping module 10 has a module housing acting as a module carrier 12, which is provided with a coupling device 18, not described in more detail, in order to be coupled, for example, to a robot arm 104 or an automatic handling machine 200.

The gripping module 10 has two active elements 20, which are displaceable guided by a shaft guide 70. The two active elements 20 have gripping jaws 22 projecting outwardly from the module housing, which have internally located gripping surfaces 22B facing toward each other and externally located gripping surfaces 22A facing away from each other. By means of these gripping jaws 22 or gripping fingers attached thereto, the gripping module 10 can grip gripping objects as intended. For this purpose, the gripping jaws 22 are moved from the outside or inside to the gripping object concerned and a gripping force sufficient for handling is applied between them.

For displacement and application of force to the active elements 20, the gripping module 10 has a drive system whose components are described below.

The drive system has as its main component a drive spindle 42, which is part of a spindle component 40. A spindle nut 30 is screwed onto the drive spindle 42, which has two outwardly facing wings. These wings of the spindle nut 30 are connected to extensions 24 of the active elements 20 via intermediate levers 26. These intermediate levers 26 are, as can be seen in particular in the enlarged illustration of FIG. 2, in each case hinged to the spindle nut 30 so as to be pivotable about an axis A and to the extension 24 so as to be pivotable about an axis B2. They are thus able to convert a movement of the spindle nut 30 that takes place vertically with respect to the figures into a horizontal movement of the active elements 20.

An electric motor 50 and an electromagnet 60 are provided for moving the drive spindle 42 and the entire spindle component 40.

The electric motor 50 is a gearless and brushless DC motor whose output shaft 52 coincides with its rotor shaft, i.e. is arranged coaxially with the rotor and rotates at the speed of the motor. The output shaft 52 is inserted from above into a recess 46 of the drive spindle 42 in the manner clearly shown in FIGS. 2 and 3, whereby rotational stability is achieved between the output shaft 52 and the drive spindle 42 due to the non-circular shape of both the output shaft 52 and the recess 46. However, axial mobility remains since there is no axial coupling between the output shaft 52 and the drive spindle 42.

The electromagnet 60 also acts on the spindle component 40 via an actuator 64, which is pressed by a spring device 62 in the form of a helical compression spring in the direction of an upper end position. The electromagnet 60 makes it possible to attract this actuator element 64 against the force of the spring device 62, so that the actuator element 64 rests against the electromagnet 60 in its lower end position in the manner illustrated in FIG. 1. When the electromagnet 60 is deactivated, the spring device 62 expands and pushes the actuator element 64 upward with respect to the figures. The actuator element 64 has a receiving space in which a pressure plate 44 of the spindle component 40 is rotatably mounted.

Due to this design, it is possible to raise and lower the drive spindle 42 and with it the spindle nut 30 to a limited extent via activation and deactivation of the electric motor 60.

For controlling the electric motor 50 and the electromagnet 60, the gripping module 10 has a control board 90, which is connected to the electric motor 50 and the electromagnet 60 and, if necessary, to supplementary sensors such as end position sensors in a manner not shown in greater detail. For connection of an external control line, the control board has a connection socket 92, which is placed in an opening of the module housing.

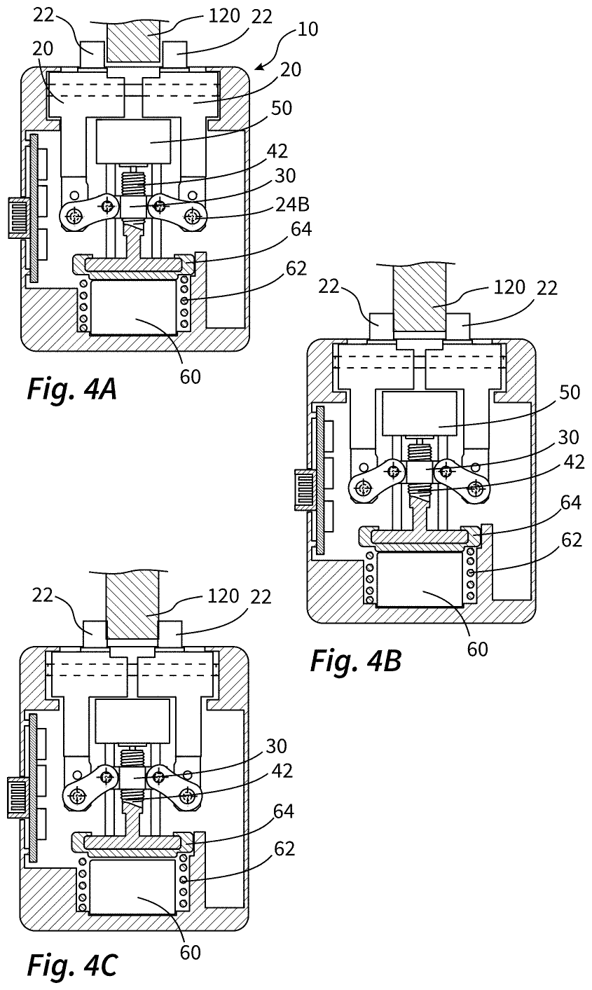

FIGS. 4A to 4C illustrate the use of the gripping module 10 as an external gripper.

FIG. 4A shows an initial state in which the electromagnet 60 is energized and thus pulls the actuator element 64 and the drive spindle 42 into a lower end position against the force of the spring device 62. By means of the electric motor, the active elements 20 are spaced apart from each other to such an extent that the gripper jaws 22 are at a distance from a gripping object 120.

Starting from this initial position, the electric motor 50 is first supplied with power by means of the control board 90 and is rotated in a direction, which leads to an upward movement of the spindle nut 30. Through this movement, the active elements 20 are moved towards each other by means of the intermediate levers 26 until they are in contact with the outside of the gripping object 120 in the manner illustrated in FIG. 4B. However, a relevant gripping force is not yet applied, since the electric motor 50 does not have sufficient power.

Starting from the state of FIG. 4B, the current supply to the electromagnet 60 is then cancelled. The effect of this is that the spring device 62 presses the actuator element 64 upwards and displaces it together with the spindle nut 30. This displacement has the effect that the force of the spring device 62, which is designed as a compression spring, is transmitted to the gripping jaws 22 and causes a gripping force that is sufficient for handling the gripping object 120.

If a power failure occurs in the state of FIG. 4C, this is irrelevant for the gripping state, since this is maintained by the spring device 62.

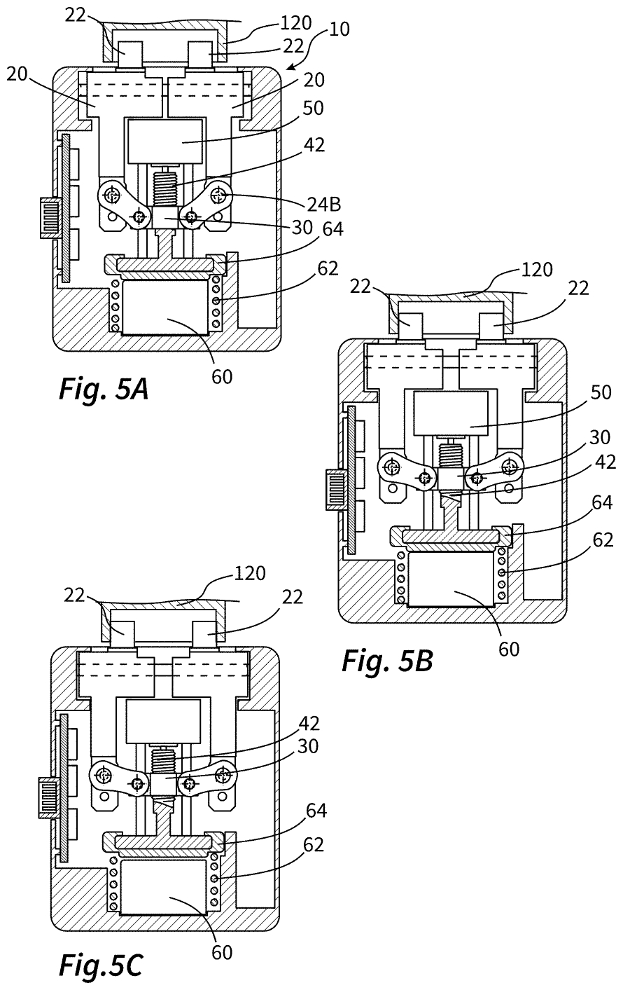

FIGS. 5A to 5C show the same gripping module, but in a different configuration, namely in the configuration of an internal gripper.

In this configuration, the intermediate levers 26 are not pivotable about the axis B2, but about the axis B1 shown in FIG. 2. Furthermore, in the initial state of FIG. 5A, the spindle nut 30 is in a significantly lowered position relative to the drive spindle 42.

The gripper jaws 22 are thus moved away from each other in this internal gripper for the purpose of gripping. This is done in a similar manner as already explained for FIGS. 4A to 4C.

Starting from the state of FIG. 5A, the drive spindle 42 is first rotated by means of the electric motor 50 so that the spindle nut 30 is raised and, due to the geometric conditions now prevailing, the active elements 20 are pushed away from each other via the intermediate levers 26 until they reach the end position of FIG. 5B, in which they lie opposite each other on the inside of the gripping object 120.

Once this state is reached, the current supply to the electromagnet 60 is again lifted, causing the spring device 62 to push the actuator element 64 upwards. The corresponding force continues via the intermediate levers 26 to the active elements 20 and now causes a gripping force with which the gripping jaws 22 are pressed away from each other and with which they hold the gripping object 120.

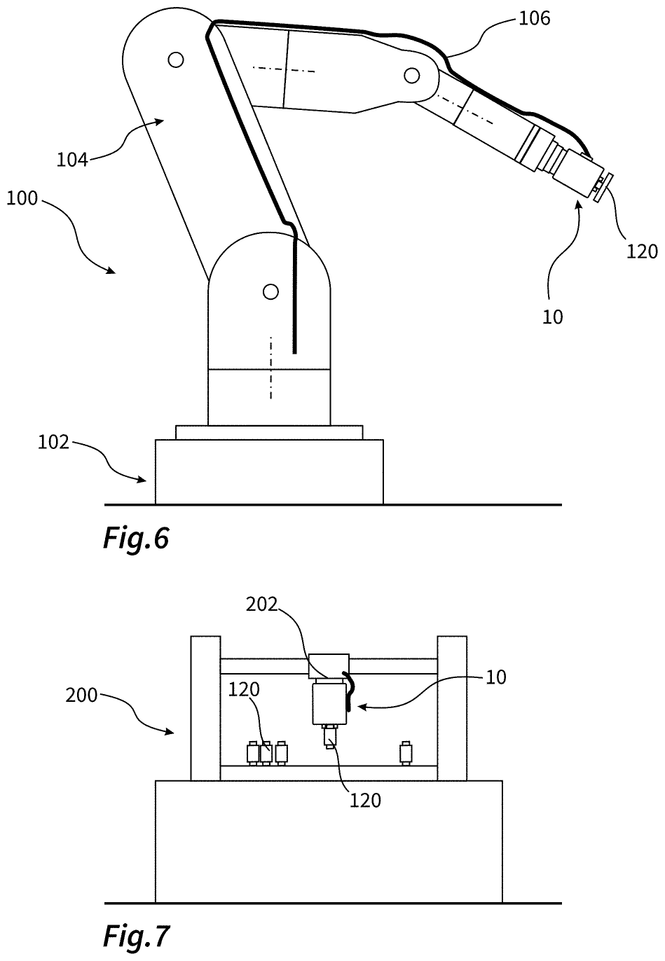

FIGS. 6 and 7 show typical applications of a gripping module corresponding to that of FIGS. 1 to 5C.

FIG. 6 shows a robot 100 that has a multi-link robot arm 104 that is movable relative to a base 102. A coupling device is provided at the distal end of this robot arm 104, to which the gripping module 10 is attached by means of its coupling device 18. The gripping module 10 is connected to the robot 100 via a control line 106. In this configuration, the robot can be used to grasp, transport and deposit gripping objects 120.

FIG. 7 shows a handling robot 200, which has a carriage 202 that can be moved in all three spatial axes. On the underside, the carriage 202 has a coupling interface to which a gripping module 10 corresponding to that of FIGS. 1 to 5C is coupled by means of its coupling device 18. The gripping module 10 can thus be moved freely in space with constant orientation, in particular with downward orientation, grasp gripping objects 120, transport them and deposit them again at a different location.

What is claimed is:

1. A gripping module for gripping and moving objects, the gripping module comprising:
a module carrier;
two active elements that are displaceable relative to one another, wherein each of the two active elements has a gripping surface for gripping an object; and
a drive system that is configured to displace at least one of the two active elements relative to the module carrier,
wherein the drive system includes
an electric motor,
an electromagnet, and
an actuator element displaceable by means of the electromagnet,
wherein the electric motor and the actuator element are kinematically coupled to the at least one of the two active elements.

2. The gripping module of claim 1, wherein the drive system is configured to displace the two active elements toward and away from each other relative to the module carrier.

3. The gripping module of claim 1, further comprising:
a drive spindle that is rotatably movable relative to the module carrier and that is axially movable; and
a translationally displaceable spindle nut that is guided on the drive spindle and is kinematically coupled to the at least one of the two active elements.

4. The gripping module of claim 3, wherein the drive spindle is rotationally coupled to the electric motor and axially displaceable by means of the actuator element.

5. The gripping module of claim 3, wherein the electric motor is fixedly attached to the module carrier, and wherein an output shaft of the electric motor and the drive spindle are connected to each other in a rotationally fixed and axially displaceable manner.

6. The gripping module of claim 5, wherein at least one portion of the output shaft has a non-circular cross section, and wherein the drive spindle has a non-circular centric recess configured to receive the at least one portion of the output shaft.

7. The gripping module of claim 3, wherein the electric motor and the actuator element are provided opposite each other on both sides of the drive spindle.

8. The gripping module of claim 3, wherein the spindle nut is connected to the at least one of the two active elements via an intermediate lever, and wherein the intermediate lever is pivotally movable about an axis stationary relative to the at least one of the two active elements and about an axis stationary relative to the spindle nut.

9. The gripping module of claim 8, further comprising at least two swivel joint bores or swivel joint axes that are provided on at least one of the spindle nut or the at least one of the two active elements so that the intermediate lever can be pivotably attached to the spindle nut or the at least one of the two active elements in two different positions.

10. The gripping module of claim 1, further comprising a drive spindle that is rotatably movable relative to the module carrier, wherein the drive spindle is connected in a rotationally fixed manner to a pressure plate, and wherein the actuator element has a receiving space for receiving the pressure plate.

11. The gripping module of claim 1, further comprising a spring device that is configured to be tensioned by activation of the electromagnet.

12. The gripping module of claim 10, wherein the spring device has a spring end that rests on the actuator element.

13. The gripping module of claim 10, wherein the spring device acts on the actuator element in such a way that the active element is force-loaded in a gripping direction.

14. The gripping module of claim 10, wherein the spring device comprises a compression spring.

15. The gripping module of claim 1, wherein the electric motor is arranged between the two active elements.

16. The gripping module of claim 1, wherein the at least one of the two active elements is guided by a linear guide so as to be movable relative to the module carrier.

17. The gripping module of claim 1, comprising at least one sensor configured to detect a position or an end position of the at least one of the two active elements.

18. The gripping module of claim 1, wherein the gripping module is a robot gripper, and wherein the module carrier comprises a coupling device that is configured to attach the gripper module to a robot arm of a robot.

19. The gripping module of claim 1, wherein the electric motor has a maximum power that results in a maximum force between the two active elements of less than 50 Newton.

20. A robot comprising a robot arm and the gripping module of claim 1, wherein the gripping module is attached to the robot arm.

21. A handling machine comprising a carriage and the gripping module of claim 1, wherein the carriage is translationally movable and the gripping module is attached to the carriage.

22. A method of gripping an object, the method comprising:
a. positioning two active elements of a gripping module in an initial position in which the two active elements are positioned at a distance from surfaces of the object;
b. displacing at least one of the two active elements by an electric motor until the active elements are in contact with the surfaces of the object; and
c. activating or deactivating an electromagnet, whereby the at least one of the two active elements is force-loaded and exerts a gripping force on the object.
